(19) United States
(12) Patent Application Publication
(10) Pub. No.: US 2013/0108812 A1
(43) Pub. Date: May 2, 2013

(54) HOUSING AND METHOD FOR MAKING THE SAME

(71) Applicant: YONG-GANG ZHU, Shenzhen City (CN)

(72) Inventor: YONG-GANG ZHU, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/414,867

(22) Filed: Mar. 8, 2012

(30) Foreign Application Priority Data
Oct. 27, 2011 (CN) 201110331584.7

(51) Int. Cl. B32B 1/02; B32B 38/00; B32B 37/06; B32B 3/10

(52) U.S. Cl. 428/34.6; 156/89.12

(57) ABSTRACT

A housing includes a substrate, a base ceramic layer formed on a surface of the substrate, a transparent ceramic layer formed on the base ceramic layer, and a pattern layer formed between the base ceramic layer and the transparent ceramic layer, the pattern layer is a ceramic layer embedded in the base ceramic layer. The housing has an attracting appearance.

### BACKGROUND

1. Technical Field

The present disclosure relates to a housing and a method for making the housing.

2. Description of Related Art

Metallic housings of electronic devices are usually surface treated to form patterns to present attractive appearances. The surface treating method may be a laser engraving process, an anodic oxidation process, or a chemical etching process. However, patterns formed by these methods commonly can't present a novel and consumer appealing appearance.

Therefore, there is room for improvement within the art.

### BRIEF DESCRIPTION OF THE FIGURE

Many aspects of the housing can be better understood with reference to the following drawing. The components in the drawing are not necessarily drawn to scale, the emphasis instead being placed upon clearly illustrating the principles of the housing. Moreover, in the drawing like reference numerals designate corresponding parts throughout the several views. Wherever possible, the same reference numbers are used throughout the drawings to refer to the same or like elements of an embodiment.

FIG. 1 is a cross sectional view of an exemplary embodiment of a housing.

FIG. 2 is a schematic view of a ceramic stained paper.

### DETAILED DESCRIPTION

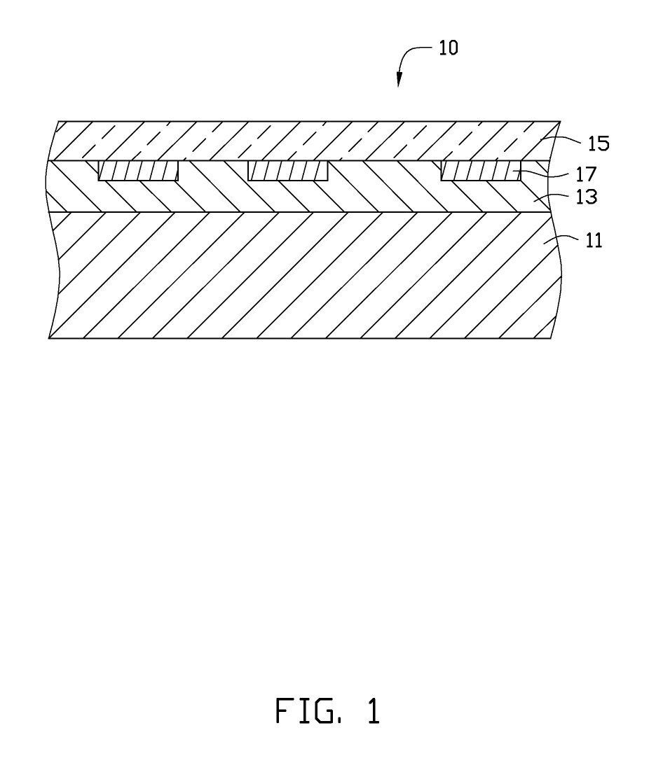

FIG. 1 shows a housing 10 according to an exemplary embodiment. The housing 10 includes a substrate 11, a base ceramic layer 13 formed on a surface of the substrate, and a transparent ceramic layer 15 formed on the base ceramic layer 13. A pattern layer 17 is defined between the base ceramic layer 13 and the transparent ceramic layer 15. The pattern layer 17 is embedded in the base ceramic layer 13. The housing 10 may be a housing of an electronic device, such as mobile phone.

The substrate 11 can be made of stainless steel or titanium alloy.

The base ceramic layer 13 contains silicon oxide with a mass percentage of about 60% to about 70%, aluminum oxide with a mass percentage of about 15% to about 20%, a coloring agent with a mass percentage of about 5% to about 10%, potassium oxide with a mass percentage of about 5% to about 6%, sodium oxide with a mass percentage of about 4% to about 6%, magnesium oxide with a mass percentage of about 0.4% to about 0.6%, iron oxide with a mass percentage of about 0.2% to about 0.4%, and calcium oxide with a mass percentage of about 0.2% to about 0.4%. The coloring agent is one chosen from a group consisting of titanium dioxide, ferric oxide, ferroferric oxide, and cobalt oxide. The coloring agent makes the base ceramic layer 13 to present a white, black, red or blue color. In the embodiment, the coloring agent is titanium dioxide and makes the base ceramic layer 13 to present a white color. The base ceramic layer 13 has a thickness of about 0.15 mm to about 0.18 mm.

The transparent ceramic layer 15 contains silicon oxide with a mass percentage of about 75% to about 85%, aluminum oxide with a mass percentage of about 5% to about 12%, potassium oxide with a mass percentage of about 5% to about 8%, sodium oxide with a mass percentage of about 4% to about 6%, magnesium oxide with a mass percentage of about 0.4% to about 0.6%, iron oxide with a mass percentage of about 0.2% to about 0.4%, and calcium oxide with a mass percentage of about 0.2% to about 0.4%. The transparent ceramic layer 15 has a thickness of about 0.08 mm to about 0.1 mm.

The pattern layer 17 contains the same components as that of the base ceramic layer 13 except for the coloring agent component. The coloring agent of the pattern layer 17 is different from that of the base ceramic layer 13, so the pattern layer 17 presents a different color from that of the base ceramic layer 13. In the embodiment, the coloring agent of the pattern layer 17 is cobalt oxide and makes the pattern layer 17 to present a blue color.

A method for making the housing 10 may include the following steps:

The substrate 11 is provided and pretreated. The substrate 11 is made of stainless steel or titanium alloy. The pretreatment includes step of degreasing the substrate by oxalic acid solution or sodium hydroxide solution.

The substrate 11 is sand blasted to roughen its surface and improve bond between the substrate 11 and subsequent layers. The roughness (Ra) of the substrate 11 is about 1.3 μm to about 2.0 μm.

[0 015] The base ceramic layer 13 is formed on the substrate 11 using an electrostatic spraying process. An electrostatic spraying machine (not shown) is provided. The spraying material for forming the base ceramic layer 13 contains silicon oxide with a mass percentage of about 60% to about 70%, aluminum oxide with a mass percentage of about 15% to about 20%, coloring agent (titanium dioxide) with a mass percentage of about 5% to about 10% potassium oxide with a mass percentage of about 5% to about 6% sodium oxide with a mass percentage of about 4% to about 6%, magnesium oxide with a mass percentage of about 0.4% to about 0.6%, iron oxide with a mass percentage of about 0.2% o about 0.4%, and calcium oxide with a mass percentage of about 0.2% to about 0.4%.

After the spraying process, the sprayed substrate 11 is sintered at an internal furnace temperature of about 800° C. to about 805° C. for about 3 min to about 5 min, then the sintered product is naturally cooled in the furnace. The spraying material coated on the substrate will melt by sintering and will solidify to form the base ceramic layer 13 during the cooling process. The base ceramic layer 13 has a thickness of about 0.15 mm to about 0.18 mm.

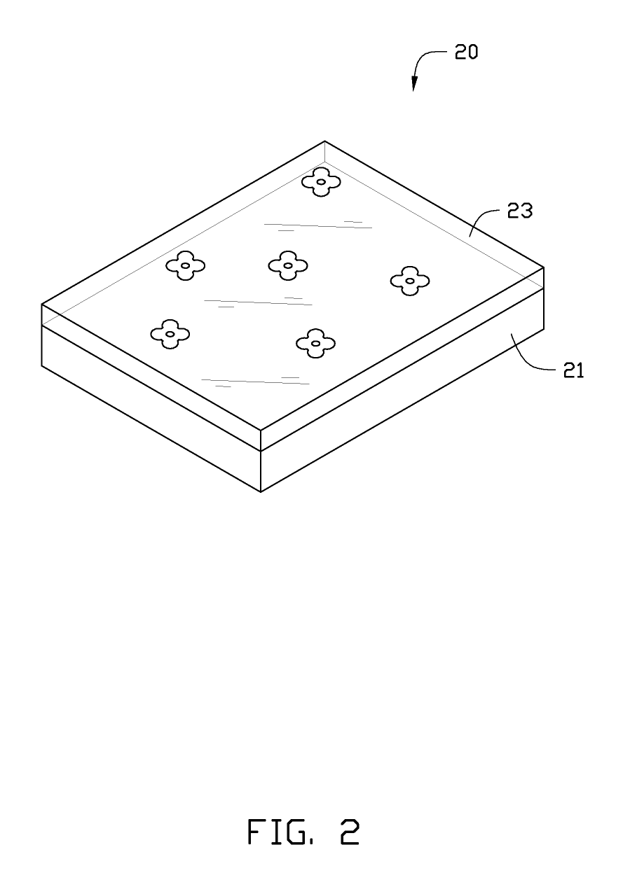

The pattern layer 17 is formed in the base ceramic layer 13 using a ceramic stained paper 20 shown in FIG. 2. The ceramic stained paper 20 includes a base paper 21 and a pattern film 23 attaching to the base paper 20. The pattern film 23 is peeled from the base paper 20 and is attached to the base ceramic layer 13, then the base ceramic layer 13 attached with the pattern film 23 is sintered at an internal furnace temperature of about 780° C. to about 785° C. for about 3 min to about 5 min, then the sintered product is naturally cooled in the furnace. During the sintering, the pattern film 23 melts and embeds in the base ceramic layer 13 to form the pattern layer 17.

The transparent ceramic layer 15 is formed on the base ceramic layer 13 by electrostatic spraying using the electrostatic spraying machine. The spraying mate for the transparent ceramic layer 15 contains silicon oxide with a mass percentage of about 75% to about 85%, aluminum oxide with a mass percentage of about 5% to about 12%, potassium oxide with a mass percentage of about 5% to about 8%, sodium oxide with a mass percentage of about 4% to about 6%, magnesium oxide with a mass percentage of about 0.4% to about 0.6%, iron oxide with a mass percentage of about 0.2% to about 0.4%, and calcium oxide with a mass percentage of about 0.2% to about 0.4%. After spraying, the sprayed product is sintered at an internal furnace temperature of about 730° C. to about 750° C. for about 5 min to about 8 min, and then the sintered product is naturally cooled in the furnace.

The surface of the substrate 11 opposite to the transparent ceramic layer 15 is sand blasted to remove the oxide layer formed on the substrate 11 during the sintering processes.

The housing 10 shows a pattern, which is novel and appealing to consumers. Furthermore, the layers formed on the substrate 11 have excellent chemical stability, and wear resistance, which can effectively extend the using time of the housing 10.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A housing, comprising:
a substrate;
a base ceramic layer formed on a surface of the substrate;
a transparent ceramic layer formed on the base ceramic layer; and
a pattern layer formed between the base ceramic layer and the transparent ceramic layer, the pattern layer being a ceramic layer embedded in the base ceramic layer.

2. The housing as claimed in claim 1, wherein the substrate is made of stainless steel or titanium alloy.

3. The housing as claimed in claim 1, wherein the base ceramic layer comprises silicon oxide with a mass percentage of about 60% to about 70%, aluminum oxide with a mass percentage of about 15% to about 20%, a coloring agent with a mass percentage of about 5% to about 10%, potassium oxide with a mass percentage of about 5% to about 6%, sodium oxide with a mass percentage of about 4% to about 6%, magnesium oxide with a mass percentage of about 0.4% to about 0.6%, iron oxide with a mass percentage of about 0.2% to about 0.4%, and calcium oxide with a mass percentage of about 0.2% to about 0.4%.

4. The housing as claimed in claim 3, wherein the coloring agent is one chosen from a group consisting of titanium dioxide, ferric oxide, ferroferric oxide, and cobalt oxide.

5. The housing as claimed in claim 1, wherein the pattern layer comprises silicon oxide with a mass percentage of about 60% to about 70%, aluminum oxide with a mass percentage of about 15% to about 20%, a coloring agent with a mass percentage of about 5% to about 10%, potassium oxide with a mass percentage of about 5% to about 6%, sodium oxide with a mass percentage of about 4% to about 6%, magnesium oxide with a mass percentage of about 0.4% to about 0.6%, iron oxide with a mass percentage of about 0.2% to about 0.4%, and calcium oxide with a mass percentage of about 0.2% to about 0.4%.

6. The housing as claimed in claim 5, wherein the coloring agent is one chosen from a group consisting of titanium dioxide, ferric oxide, ferroferric oxide, and cobalt oxide.

7. The housing as claimed in claim 1, wherein the transparent ceramic layer comprises silicon oxide with a mass percentage of about 75% to about 85%, aluminum oxide with a mass percentage of about 5% to about 12%, potassium oxide with a mass percentage of about 5% to about 8%, sodium oxide with a mass percentage of about 4% to about 6%, magnesium oxide with a mass percentage of about 0.4% to about 0.6%, iron oxide with a mass percentage of about 0.2% to about 0.4%, and calcium oxide with a mass percentage of about 0.2% to about 0.4%.

8. The housing as claimed in claim 1, wherein the base ceramic layer has a thickness of about 0.15 mm to about 0.18 mm.

9. The housing as claimed in claim 1, wherein the transparent ceramic layer has a thickness of about 0.08 mm to about 0.1 mm.

10. A method for making a housing, comprising:
providing a substrate;
forming a base ceramic layer on the surface of the substrate by electrostatic spraying and sintering;
providing a ceramic stained paper comprising a pattern film;
attaching the pattern film to the base ceramic layer and then sintering to form a pattern layer in the base ceramic layer; and
forming a transparent ceramic layer on the surface of the pattern layer and the base ceramic layer by electrostatic spraying and sintering.

11. The method as claimed in claim 10, wherein electrostatic spraying material for the base ceramic layer comprises silicon oxide with a mass percentage of about 60% to about aluminum oxide with a mass percentage of about 15% to about 20% titanium dioxide with a mass percentage of about 5% to about 10%, potassium oxide with a mass percentage of about 5% to about 6%, sodium oxide with a mass percentage of about 4% to about 6%, magnesuim oxide with a mass percentage of about 0.4% to about 0.6% iron oxide with a mass percentage of about 0.2% to about 0.4%, and calcium oxide with a mass percentage of about 0.2% to about 0.4%.

12. The method as claimed in claim 11, wherein the sintering in the step of forming the base ceramic layer is carried out at an internal furnace temperature of about 800° C. to about 805° C. for about 3 min to about 5 min.

13. The method as claimed in claim 10, wherein the sintering in the step of forming the pattern layer is carried out at an internal furnace temperature of about 780° C. to about 785° C. for about 3 min to about 5 min.

14. The method as claimed in claim 10, wherein electrostatic spraying material for the transparent ceramic layer comprises silicon oxide with a mass percentage of about 75% to about 85%, aluminum oxide with a mass percentage of about 5% to about 12%, potassium oxide with a mass percentage of about 5% to about 8%, sodium oxide with a mass percentage of about 4% to about 6%, magnesium oxide with a mass percentage of about 0.4% to about 0.6%, iron oxide with a mass percentage of about 0.2% to about 0.4%, and calcium oxide with a mass percentage of about 0.2% to about 0.4%.

15. The method as claimed in claim 14, wherein the sintering in the step of forming the transparent ceramic layer is carried out at an internal furnace temperature of about 730° C. to about 750° C. for about 5 min to about 8 min.

16. The method as claimed in claim 10, wherein the substrate is made of stainless steel or titanium alloy.

17. The method as claimed in claim 10, further comprising a step of roughening the substrate prior to forming the base ceramic layer.

18. The method as claimed in claim 17, wherein the roughening method is sand blasting.
